(19) United States
(12) Patent Application Publication
(10) Pub. No.: US 2003/0119495 A1
(43) Pub. Date: Jun. 26, 2003

(54) Method and arrangement for controlling calls in a hybrid cellular telecommunication system

(76) Inventors: Timo Hanninen, Tampere (FI); Markku Rautiola, Tampere (FI); Tapio Siik, Lempaala (FI); Petri Uosukainen, Tampere (FI); Hannu Honkala, Tampere (FI); Pekka Rissanen, Tampere (FI); Kai Narvanen, Tampere (FI); Roy Mickos, Tampere (FI); Jukka Liimatainen, Ylojarvi (FI)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/168,376

(22) PCT Filed: Dec. 20, 2000
(86) PCT No.: PCT/FI00/01117

(30) Foreign Application Priority Data
Dec. 20, 1999 (FI) 19992730

(51) Int. Cl. H04M 3/42; H04Q 7/20

(52) U.S. Cl. 455/422; 455/414

(57) ABSTRACT

A method (400) for controlling calls to and from a mobile station reachable via a hybrid cellular telecommunication system, where said mobile station is the first endpoint of a call, is characterized in that a set of allowed location areas is defined (402). Further, the location area of another endpoint of the call is determined (407), and decision about connecting the call via the hybrid cellular telecommunication system is made (408) based at least on the location area of said other endpoint. Arrangements (600, 610) implementing the method are also presented.

The invention relates in general to hybrid cellular telecommunication systems that are systems combining cellular and other network technologies. The invention relates in particular to allowing calls only to certain subsystems of the hybrid cellular telecommunication system.

Traditionally separate networks have been used for transferring data and voice. Data is nowadays transferred mainly in packet based networks, especially in Internet Protocol (IP) networks. These networks can, for example, be simple local area networks (LANs) or complex interconnected corporate networks. Voice calls have traditionally been transmitted in circuit switched networks. In the recent years, however, there has been an explosive growth in real-time data applications that use packet based networks like the Internet as transport medium. These real-time applications can support voice and videocalls, and, for example, the IP-calls are expected to be less expensive than calls in traditional fixed or mobile networks.

The H.323 specification has been created by the International Telecommunications Union (ITU) for the purpose of defining a standard framework for audio, video and data communications over networks that do not provide a guaranteed quality of service (QoS). Packet based networks, for example, can be such networks. The aim of the H.323 specification is to allow multimedia products and applications from different manufacturers to interoperate. The H.323 specification defines functionality for call control multimedia management, and bandwidth management as well as interfacing between networks. The H.323 specification defines four major components for a network-based communications system: terminals, gateways, gatekeepers, and multipoint control units. H.323 terminals, gateways and gatekeepers will be shortly described in the following. The multipoint control unit is needed for conference calls, where there are at least three participants.

A terminal is a client device in the network. It typically provides real-time, two-way communication for the user. All H.323 terminals must support voice communications, and they may also support video and data communications. A terminal can be realized using a personal computer, or the terminal may be a stand alone unit such as a conventional telephone. Further examples of terminals are Internet telephones, audio conferencing terminals, and video conferencing terminals.

A gateway is used to connect a H.323 network to other types of networks and/or terminal types. A gateway may, for example, translate information transmission formats or protocols between the networks. A H.323 gateway, which may be distributed, can also participate in call setup and other procedures between the networks.

A gatekeeper functions as a controlling unit for a given section of an H.323 network, i.e. an H.323 zone. A gatekeeper provides call control services to registered endpoints, e.g., H.323 terminals or gateways. Further, a gatekeeper performs address translation between local area network aliases for terminals and gateways to IP or other network addresses. A gatekeeper may also perform bandwidth management, i.e., transmission resource control. Registration, address translation and bandwidth management employ Registration, Admission and Status (RAS) signaling.

The gatekeeper can also be used to route H.323 calls, in which case the calls are under control of the gatekeeper. This allows a simple way of providing many different kinds of services and traffic management features. While the concept of a gatekeeper is logically separate from the concept of a gateway or a multipoint control unit, the gatekeeper can be realized in the same physical device as a gateway or a multipoint control unit.

Usually calls that involve a mobile station are transferred at some point of the connection over fixed lines that are either part of the cellular network or part of the traditional Public Switched Telephone Network (PSTN). Systems that use other fixed networks, especially packet based networks, for transferring at least some of the mobile-originated or mobile-terminated calls have been recently developed. These systems are here called hybrid cellular telecommunication systems, and an example of them is the Rich Call Platform.

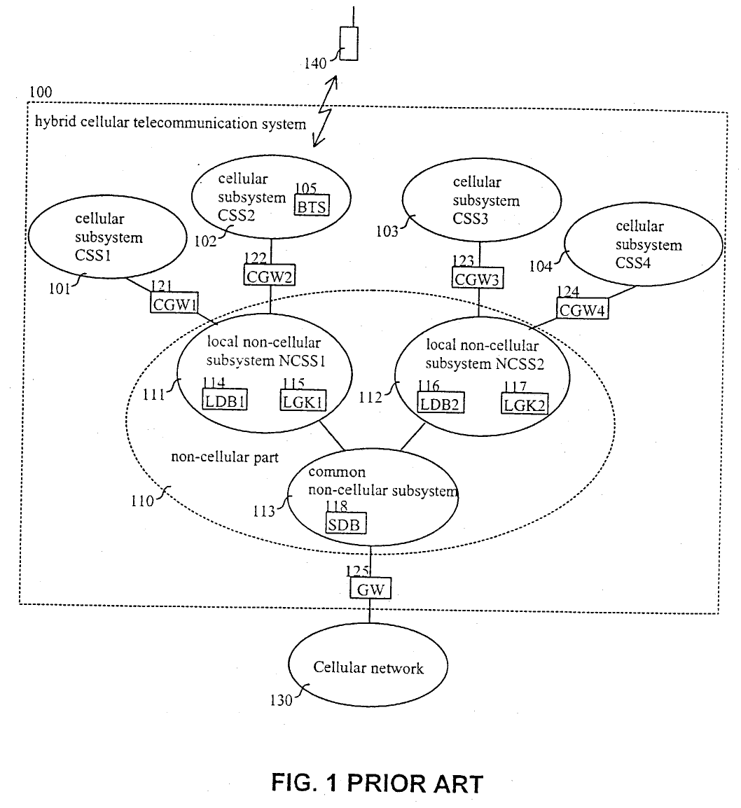

An example of a hybrid cellular communication system is illustrated in FIG. 1. The system 100 comprises cellular subsystems 101-104 which employ cellular techniques that support communications with a mobile station 140. Each of the cellular subsystem contains at least one base station or a corresponding network element, and as an example, FIG. 1 shows the base station 105 in the cellular subsystem 102. The rest of the system 100 may be implemented using other network techniques, for example IP networks and H.323 standard. The non-cellular part 110 of the hybrid cellular telecommunication system includes two local non-cellular subsystems 111 and 112, and a common non-cellular part 113 to which the noncellular subsystems are connected via, for example, the Internet.

The local non-cellular subsystems 111 and 112 may be in two different premises of a company, and they are used to transmit calls and connections to the mobile stations via the cellular subsystems. The local non-cellular subsystems need to have an entity that routes the calls (corresponding to the H.323 gatekeeper) and a database where to store information about the terminals that are reachable via the cellular subsystems. In FIG. 1 these elements have been presented with local gatekeepers 115 and 117 and local databases 114 and 116. The cellular gateways 121-124 connect a cellular subsystem to a local non-cellular subsystem, and they are responsible for making, for example, necessary protocol transformations. The gateways are called here cellular gateways just to differentiate them from the other gateways possibly involved in hybrid cellular telecommunication systems.

When the cellular subsystems of a hybrid cellular telecommunication system cover, for example, all offices and buildings of a company, mobile calls from one office to another can be made using the non-cellular part of the system as fixed transmission media. The calls need not go through public cellular or fixed telephony networks, i.e. not through the public gateway 125. Especially if the company has offices around the world, this can result in considerable savings in telephony charges.

The hybrid cellular telecommunication system 100 is connected to the public cellular network 130 via the public gateway 125. The public cellular network 130 is typically owned, managed and maintained by a cellular network operator, whereas the cellular subsystems (in FIG. 1, for example, the cellular subsystems 101-104) may be operated, for example, by a cellular network operator or by the company in whose premises the cellular subsystems are.

Both calls and signaling information may be passed through the public gateway 125. Calls where the other endpoint is not within the hybrid cellular telecommunication system are routed through the public cellular network 130 in the example presented in FIG. 1. The common non-cellular part 113 to which the gateway 125 is connected, may be in the premises of the cellular network operator. Information about the mobile stations and subscribers that are allowed to use the hybrid cellular telecommunication system needs to be stored in the system, for example in a subscriber database 118.

In a sense, the hybrid cellular telecommunication system is an extension to the public cellular network 130. The hybrid cellular telecommunication system may rely on having access to certain service provided by the public cellular network 130. For example, necessary subscriber information may be fetched from the public cellular network. The public cellular network needs to be notified of the mobile stations that are reachable through the hybrid cellular telecommunication system. Otherwise it cannot, for example, route incoming calls correctly.

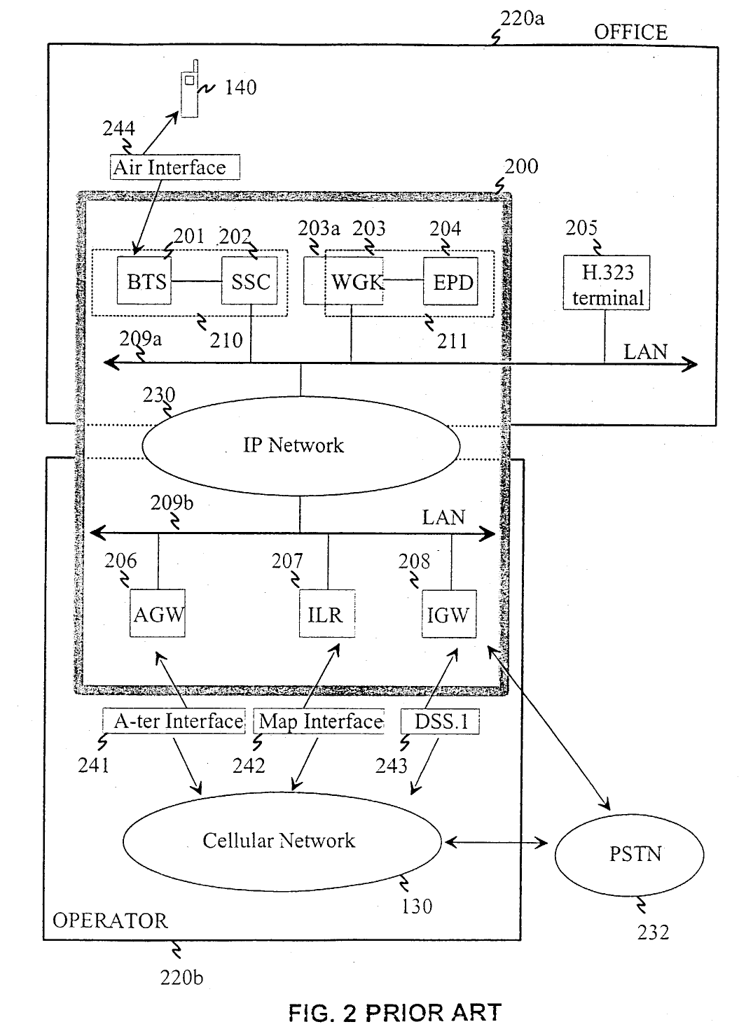

The Rich Call Platform (RCP), which combines parts and subsystems of a certain cellular system and fixed network techniques, is used here as a more tangible example of a hybrid cellular telecommunication system. FIG. 2 presents a schematic drawing of one RCP system 200, which employs Global System for Mobile Communications (GSM) as the cellular system and the combination of H.323 standard and IP network for transmitting part of the calls over fixed network. Part of the RCP system is within the corporate premises 220a. This part comprises a local area network 209a, where the calls and information related to the calls is presented in H.323 format, and at least one cellular subsystem. The LAN 209a is connected via an IP-based network 230 to another LAN 209b which is operated by the cellular network operator 220b and is usually situated in the premises of the cellular network operator. LANs 209a and 209b do not have to be situated in the same premises as long as both are connected to the same IP network 230.

Each of the cellular subsystems situated in the corporate premises 220a comprises one or more Base Transceiver Stations (BTS) 201 and a subsystem controller (SSC) 202 to which the base transceiver stations are connected. In RCP system, the subsystem controller is usually called IMC (Intranet Mobility Cluster). The SSC provides to the BTS same interfaces as BSC, but the actual functionalities are typically distributed between different RCP entities. The SSC acts also as a gateway between the cellular subsystem which it controls and the H.323 part of the RCP system. The SSC 202 is connected to the local area network 209a of the office 220a.

A gatekeeper (WGK) 203 is a H.323 gatekeeper where some GSM features have been added. It is involved in signaling in the RCP system. It acts as a central point for all calls within its zone and provides call control and management services, such as network topology information, update of RCP subscriber information, address translation during call set-up, admission control and bandwidth control. In many ways gatekeeper acts as a virtual switch. Thus gatekeepers are sometimes called also Mobile Telephone Servers (MTS). Each RCP zone can be managed by one gatekeeper.

The cellular subsystem 210 and the non-cellular subsystem 211 of RCP system 200 are presented with dashed lines in FIG. 2. A part 203a of the gatekeeper 203 forms the cellular gateway of the RCP system 200 (corresponding, for example, to the cellular gateway 121 in FIG. 1).

Information about the presence of each mobile station and H.323 compatible terminals 205 in a RCP system is stored in an End Point Database (EPD) 204 which either is connected to the gatekeeper 203 or is a part of the gatekeeper. Using the information stored in the EPD 204 the gatekeeper 203 can determine, if the destination address of the call is within its control zone. This information is needed when setting up calls in the RCP system.

In the second LAN 209b, there are an A-interface Gateway (AGW) 206 and an Intranet Location Register (ILR) 207. The A-interface gateway 206 handles communications between the RCP system 200 and the public cellular network 130 via a A-ter-type interface 241. The A-ter interface is an interface normally found between Transcoder Submultiplexer (TCSM) and Base Station Controller in GSM-networks. Therefore the communications between the RCP system 200 and the public cellular network 130 can be handled like normal communications between Base Stations Subsystem and the public cellular network 130, the RCP-system 200 acting like a normal Base Station Subsystem from the view point of the public cellular network 130. The AGW is responsible for converting speech and data streams and signaling between the public cellular network and the H.323 part of the RCP system. If the RCP system employs some other cellular network standard than GSM, the functionality of the AGW (or a corresponding gateway with a different name) is defined by the relevant cellular network standards.

The main function of an ILR database 207 is to store mobility management information of the subscribers using the RCP-system 200. For all subscribers that have a right to use the RCP system, there is a permanent entry in the ILR. The ILR contains both RCP-specific information, such as the IP address of the gatekeeper at whose control zone the mobile station currently is, and GSM-specific information, which is practically the same information as stored in the Visitor Location Register (VLR). The gatekeeper 203 is responsible for updating the RCP-specific information in the ILR, and the communications between ILR 207 and public cellular network 130 are handled via a MAP-interface 242. The MAP interface is a standard GSM-interface normally found between Home Location Register (HLR) and Mobile Services Switching Centre (MSC). Therefore the mobility management information from the RCP system 200 is handled from the viewpoint of the cellular system 130 just like mobility management information of a normal GSM subscriber.

When a mobile station 140 is used in an office 220a where the RCP system 200 is present, the call is received by a BTS 201, just as in normal cellular networks. The SSC 202 transforms the data which it receives from the mobile station 140 and which is carried by the uplink radio connection to IP packets according to the H.323 standard. It sends the packets further to the local area network 209a. Respectively, when data is transferred from the local area network 209a via the BTS 201 to the mobile station 140, the SSC 202 transforms received H.323 information to the suitable cellular network standard format understood by the BTS 201.

The gatekeeper 203 is responsible for the signaling involved in setting up a call. If the destination address is within the gatekeeper's control zone and the destination is H.323 terminal 205, then the connection is made directly with the H.323 terminal 205. If the destination is a mobile station 140 within the control zone of the gatekeeper 203, then the call is directed via the SSC 202 to the BTS 201 and further to the mobile station 140. If a call is made from the mobile station 140 to another RCP zone, the call is directed to the gatekeeper controlling the other RCP zone. If the destination is a mobile station, the two SSCs through which the mobile stations are reachable, are informed to establish the call.

When a call is made from the RCP system 200 to a destination that is a mobile phone reachable through the public cellular network 130 (either the mobile station owner being a RCP subscriber outside the RCP system coverage or being not at all a RCP subscriber), the gatekeeper 203 transfers the call via the packet switched network like Internet to the A-interface Gateway 206. As stated above the AGW 206 communicates with the public cellular network 130 through an A-ter interface 241. Therefore the public cellular network 130 handles the call like any normal mobile station call received by a MSC and connects the call using network specific methods and systems known per se.

If the call is made from a H.323 terminal 205 to a PSTN 232 or to a public cellular network 130, then the communication is handled by an ISDN Gateway (IGW) 208. The IGW 208 communicates with the public cellular network 130 via DSS.1 interface 243 thus looking form the point of view of the public cellular network 130 like a PBX (Private Branch eXchange). This makes it possible for H.323 terminal 205 to communicate with other mobile stations than those within the RCP system using the public cellular network 130. The IGW also handles the communications between the RCP system 200 and the PSTN network 232, and this enables the H.323 terminals to communicate with the PSTN network 232. The calls made from a mobile station 140 to PSTN network 232 can be handled either via the AGW 206 using the systems in the public cellular network 130 to connect the call to the PSTN network 232 or the call can be connected to the PSTN network 232 using the IGW 208.

In the RCP system 200 calls between mobile stations use GSM speech coding. If a mobile originated call is routed through the public cellular network to a fixed phone, the public cellular network will take care of decoding the speech. If one endpoint of a call is a mobile station in the RCP system 200 and the other is H.323 terminal, there is maybe need for decoding and re-coding the speech between the GSM coding and coding methods defined in H.323 standard.

When offering hybrid cellular telecommunication system services, there emerges a need to control the calls that are made using the hybrid cellular telecommunication system. Only subscribers of the hybrid cellular telecommunication system can make and receive calls using the hybrid cellular telecommunication system, but there may be need for restricting further the usage of these subscribers. For example, if both company A and B are using the hybrid cellular telecommunication system, they may want to use it only for the internal calls, so that calls from company A to company B and involving at least one mobile station are allowed using only the public cellular network.

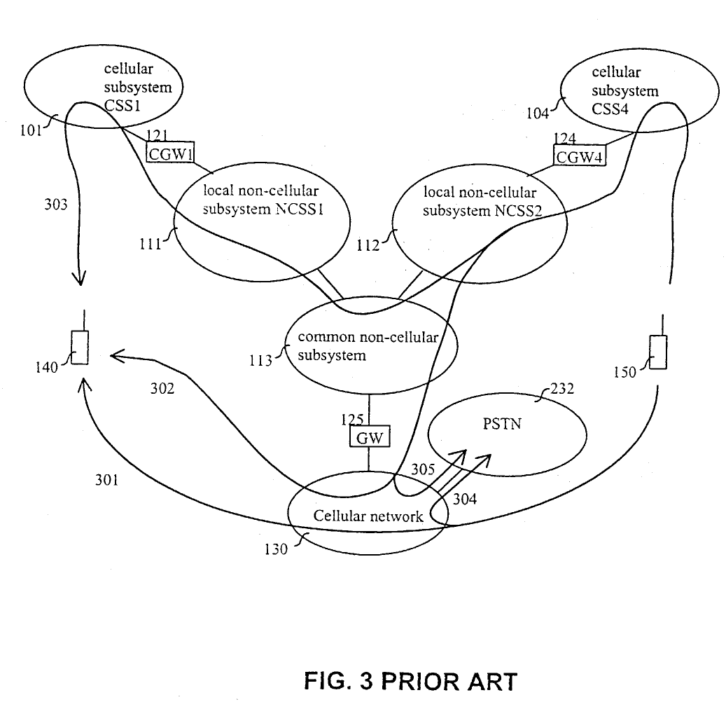

FIG. 3 illustrates in general the possibilities for routing a call from one mobile station 150 to another mobile station 140 via a hybrid cellular telecommunication system and via the cellular network 130. Two cellular subsystems 101, 104 of the hybrid cellular telecommunication system are presented in FIG. 3, as well as two local non-cellular subsystems 111, 112 and the common non-cellular subsystem 113. The gateway 125 connects the hybrid cellular telecommunication system to the cellular network 130. In FIG. 3, if the cellular subsystem 101 and local non-cellular subsystem 111 belong to company A and the cellular subsystem 104 and the local non-cellular subsystem 112 belong to company B, there may be need to reject calls from subsystem 101 to subsystem 104 although they are feasible in principle.

Arrow 301 presents the option that both the caller and receiver of the call are using the cellular network 130 for making the call. Arrow 302 presents the case where the mobile station 150 is using the hybrid cellular telecommunication system, but the mobile station 140 is using the cellular network. In this case the calls is routed via both the cellular network and the hybrid cellular telecommunication system. When both the caller mobile station 150 and receiver mobile station 140 are reachable via the hybrid cellular telecommunication system, the call can be routed as presented with arrow 303. In this case both the caller and the receiver of the call have subscribed to the hybrid cellular telecommunication system. The subscription can be either permanent or temporary.

FIG. 3 presents also the possibilities to route calls between a mobile station 150 and the fixed telephony network 232. Arrow 304 presents the case where a call is routed directly via the public cellular network 130 to the fixed telephony network 232. Arrow 305 presents the case of routing a call first via the hybrid cellular telecommunication system 104, 112, 113 to the public cellular network 130 and from there to the fixed telephony network 232.

The problem is how to decide which calls can use the resources of the hybrid cellular telecommunication system and how to choose the route if more than one route is possible. There should be a flexible method for making the decisions so that various needs of various companies, for example, can be fulfilled with the same control scheme.

The object of the invention is to present a flexible method for controlling the calls that are made using a hybrid cellular telecommunication system. Especially the object is to present a method for restricting the calls to calls made within a hybrid cellular telecommunication system. Further, the object is to present a method for restricting the calls to such calls that are made between company employees within the company premises.

This and other objects of the invention can be achieved by deciding if a first mobile station using the hybrid cellular telecommunication system is allowed to make a call to or is allowed to receive a call from another telephone based on the location area of the other telephone.

The method according to the invention for controlling calls to and from a mobile station reachable via a hybrid cellular telecommunication system, where said mobile station is the first endpoint of the call, is characterized in that

a set of allowed location areas is defined,

the location area of a second endpoint of the call is determined, and

decision about connecting the call via the hybrid cellular telecommunication system is made based at least on the location area of said second endpoint.

In the method according to the invention either the caller telephone or the receiver telephone is reachable via the hybrid cellular telecommunication system. At least one of the caller and the receiver is using a mobile station, so that at least one of the endpoints of the call is a mobile station. Because it is possible to route the call via the hybrid cellular network, either the caller or the receiver of the call is a subscriber of the hybrid cellular telecommunication system and is currently in a location area that is covered by the hybrid cellular telecommunication system. It is also possible that both the caller and the receiver of the call are reachable via the hybrid cellular telecommunication system.

According to the invention, when making a call it is possible use the hybrid cellular telecommunication system depending on the location area of the receiver and/or the identifier of the receiver. The identifier of the receiver or that of the caller may be, for example, a telephone number, a network address or a name, which corresponds to a certain network address or to a certain telephone number. For example, if the receiver of the call is a subscriber of the hybrid cellular telecommunication system and he is currently in a location area that is covered by the hybrid cellular telecommunication system, it is possible to make the call to his mobile station within the hybrid cellular telecommunication system. It is possible, however, that many companies use the same hybrid cellular telecommunication system, and they may want to restrict that their employees can make calls only to, for example, other employees of the company that are in the company premises.

The location area, where a mobile station is, can be determined by a location area code. A cellular network is divided into location areas that are given unique identifiers, i.e., the location area codes. A location area usually contains many individual cells of the cellular network. Similar codes can be given to the cell many companies use the same hybrid cellular telecommunication system, and they may want to restrict that their employees can make calls only to, for example, other employees of the company that are in the company premises.

The location area, where a mobile station is, can be determined by a location area code. A cellular network is divided into location areas that are given unique identifiers, i.e., the location area codes. A location area usually contains many individual cells of the cellular network. Similar codes can be given to the cell groups i.e. cellular subsystems of the hybrid cellular telecommunication system. For example, each cellular subsystems can be given a separate location area code or all cellular subsystems covering the premises of a certain company may have the same location area code.

The location area code thus tells whether a calling telephone (an endpoint of the call) or receiving telephone (another endpoint of the call) is in a certain location area. For calls where both parties are subscribers of the hybrid cellular telecommunication system and reachable via the system, it is thus possible to allow or reject a call based on the location area of either the caller or the receiver of the call. For example, an employer of company A may make calls to all employees of company A in the premises of the company A using the hybrid cellular telecommunication system. These calls stay within the hybrid cellular telecommunication system.

It is also possible to allow calls to be made between the hybrid cellular telecommunication system and the cellular network and still restrict the calls by the location area of the receiver of the call. In this case, if the receiver of the call is reachable via the cellular network, information about the location area has to be transmitted to the hybrid cellular network where the decision about allowing the call is made. The call is directed from the hybrid cellular telecommunication system to the cellular network and further to the receiver of the call.

If the caller or the receiver of a call is using a telephony device connected to a fixed telephony network, the location area is determined using the area codes or dialing codes that are generally used in telephony networks.

The method for controlling the calls is flexible. Any combination of the location areas and the identifiers can be used as a condition for allowing outgoing calls. For example, it is possible to allow a caller to make calls to any company employees, without any conditions about their location using the hybrid cellular telecommunication system. If the called telephone is not reachable the hybrid cellular telecommunication system, the call is directed to the cellular network at a certain point of the connection.

Similar conditions can be posed on incoming calls. When, say, an employee of company A is reachable via the hybrid cellular telecommunication system, it is possible to restrict the calls he can receive. The restriction can be made based on the location area of the caller and/or on the identifier of the caller. An employee can receive calls, for example, only from premises of the company A. In this case, employees of company A can call him via the hybrid cellular telecommunication system, and visitors via the cellular network from where the calls are directed to the hybrid cellular telecommunication system and further to the receiver of the call. Any combination of the location area and caller identifier can be used as a condition for receiving the call.

It is possible to define the allowed caller or receiver location areas and identifiers, for example, separately for each hybrid cellular telecommunication system subscriber or common allowed location areas and subscribers for a company. Both the location areas and the subscriber identifiers can be those of the hybrid cellular telecommunication system or those of the cellular network. It is also possible to define that to certain subscribers calls can be made without any restrictions concerning their location.

The method according to the invention does not restrict what happens if the call cannot be made or received using the hybrid cellular telecommunication system. It is possible that in such a case the call cannot be made or received at all, and the caller/receiver of the call has to have another mobile station with which he is reachable via the cellular network. It is possible that the caller, for example, has to use one mobile station for calls via the hybrid cellular telecommunication system and another for calls via the cellular network. If he cannot be reachable via the hybrid cellular telecommunication system, the call can be, for example, automatically forwarded to the other mobile station.

It may also be technically feasible to choose via which network a mobile station communicates when either making or receiving a call. If the call could not be made using the hybrid cellular telecommunication system, the mobile station would, for example automatically, switch to the cellular network. Same automatic switch would happen, for example, when a call which cannot be connected using the hybrid cellular telecommunication system would arrive.

The method according to the invention is applicable also in calls, which involve more than two endpoints. For example, the individual connections related to a conference call can be routed using the method according to the invention.

The invention relates also to an arrangement for controlling calls which use the resources of a hybrid cellular telecommunication system to and from a certain mobile station which is the first endpoint of a call. The arrangement comprises means for determining an identifier, which specifies another endpoint of a call, and it is characterized in that it comprises

means for determining the location area of said second endpoint,

means for defining the allowed location areas for said second endpoint, and

means for deciding whether to connect the call using the hybrid cellular telecommunication system resources or using a cellular network based at least on the location area of said second endpoint.

The invention further relates to an arrangement in a cellular network. This arrangement comprises means for determining the location area of a certain mobile station, and it is characterized in that it comprises means for receiving from an entity outside the cellular network a request comprising an identifier which specifies said mobile station and means for sending to said entity a response indicating the location area of said mobile station.

The appended dependent claims describe some preferred embodiments of the invention.

The invention will now be described more in detail with reference to the preferred embodiments by the way of example and to the accompanying drawings where

FIG. 1 shows a schematic drawing of a hybrid cellular telecommunication system,

FIG. 2 shows a schematic drawing of a RCP system,

FIG. 3 illustrates the options of routing a call via a hybrid cellular telecommunication system and via a cellular network,

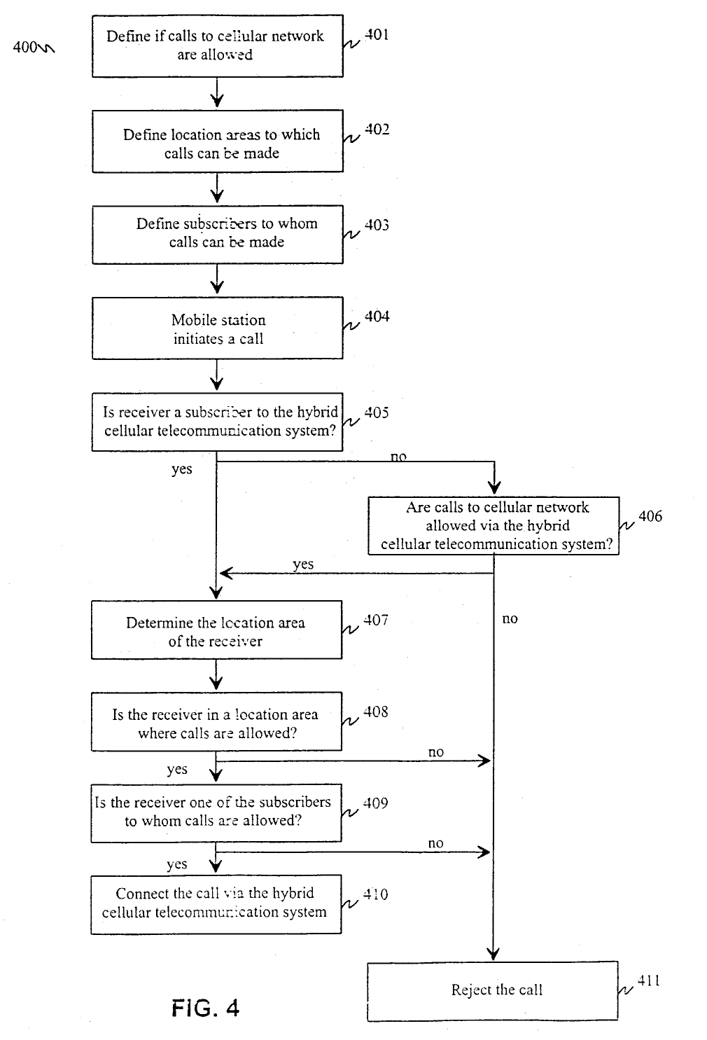

FIG. 4 shows a flowchart of the first preferred embodiment of the method according to the invention,

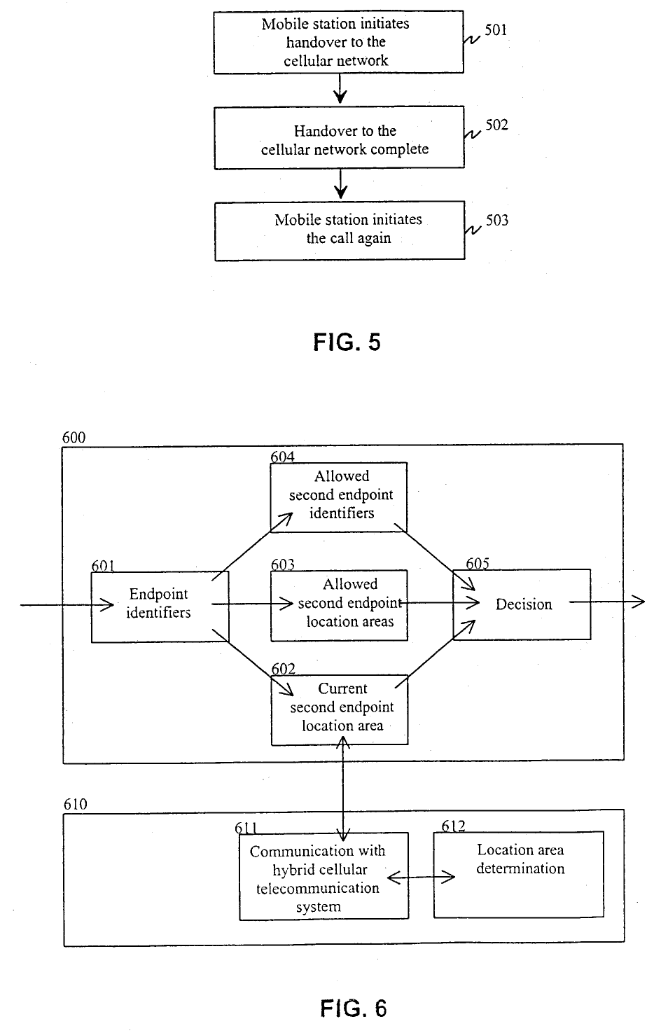

FIG. 5 shows a flowchart of the second preferred embodiment of the method according to the invention,

FIG. 6 shows schematic drawings of elements and arrangements according the present invention and

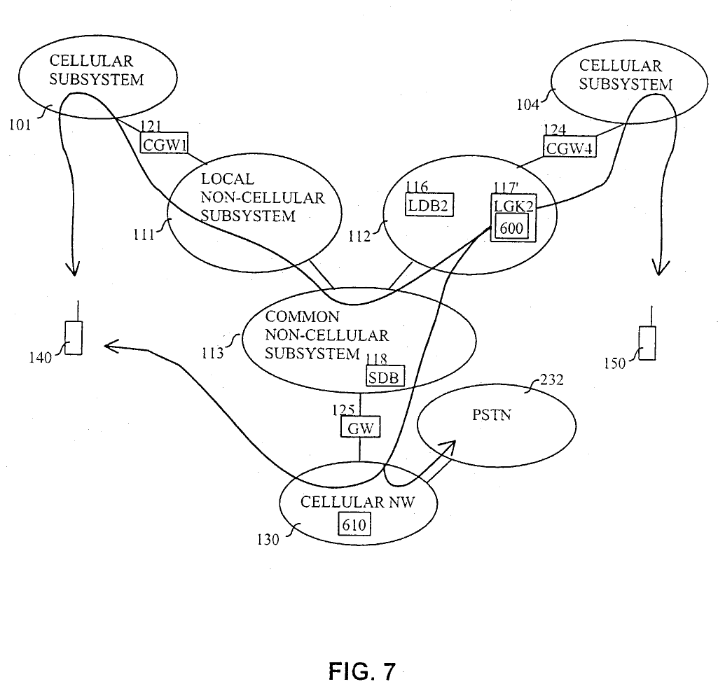

FIG. 7 shows a schematic drawing of a hybrid cellular telecommunication system and a public cellular network having arrangements according to the invention.

Above in conjunction with the description of the prior art reference was made to FIGS. 1, 2 and 3. The same reference numerals are used for corresponding parts in the figures.

In the first preferred embodiment of the method according to the invention, the calls that can be made from a hybrid cellular telecommunication system are controlled. The outgoing calls are allowed, for example, if both the caller and the receiver of the call are subscribers to the hybrid cellular telecommunication system and they are in a certain location area.

The flowchart of the first preferred embodiment of the method 400 according to the invention is presented in FIG. 4. Here it is assumed that there is no automatic handover from the hybrid cellular telecommunication system to the cellular network. This means that if it is not allowed to make a call using the hybrid cellular telecommunication system, the call is not made.

In the first step 401 it is defined if it is allowed to make calls that use other resources than only the hybrid cellular telecommunication system. In other words, it is defined if calls according to arrow 302 or 305 can be made.

In step 402 the location area to which calls are allowed to be made within the hybrid cellular telecommunication system are defined. If, for example, it is wanted that only calls between company A premises are allowed, then the location area codes of the cellular subsystems covering company A premises are listed here. It is of course also possible to define here the areas to which calls cannot be made, and all other areas are implicitly allowed.

If there is need to control that calls are made only to company A employees in the company A premises, then in step 403 the subscribers to whom call can be made are defined. For example, there can be a list of the subscriber identities of the employees. If, for example, all visitors that are in the company A premises and have subscribed to the hybrid cellular telecommunication system can receive calls via the hybrid cellular telecommunication system, the allowed subscriber identities may comprise all subscribers of the hybrid cellular telecommunication system.

In step 404 the caller initiates the call. Before this is possible, the caller's mobile station has, at some point, register itself to the hybrid cellular telecommunication system and the system has checked that he has the right to use the system at all.

After the call is initiated, it is first checked if the receiver of the call is a subscriber to the hybrid cellular telecommunication system (step 405). In step 406 it is checked if it is allowed to make calls outside the hybrid cellular telecommunication system. If this is not allowed, the call is rejected in step 411.

If the receiver of the call is a subscriber to the hybrid cellular telecommunication system, the location area of the receiver is found out in step 407. If the location area is not among the areas where calls are allowed, then the call is rejected after step 408. In step 409 the identity of the receiver is checked, if calls only to certain subscribers, e.g. company A employees, were allowed. In the last step 410 the call is connected via the hybrid cellular telecommunication system.

It is also possible to allow calls which are made to outside of the hybrid cellular telecommunication system. In other words, to allow calls according to arrow 302 or 305. The area of the cellular network to which calls can be made can be specified using the location area codes of the cellular network and the location areas related to the fixed telephony network using dialing codes. In this case, in step 401 location area codes of both the hybrid cellular telecommunication system and the cellular system and dialing codes are defined. In step 407 the location area of the receiver may have to be asked from the cellular network or it is determined based on the dialing code. The hybrid cellular telecommunication system and the cellular network may need, for example, a specific protocol for transmitting the location information of the receiver of the call.

It is also possible to construct additional rules for allowing a call to be made. For example, calls to any fixed phones may be allowed. These calls can be routed via the cellular network to the fixed network. Calls to certain subscribers may also be allowed independently of the location of the receiver of the call.

In the first preferred embodiments of the method according to the invention, if a call is not allowed to be made via the hybrid cellular telecommunication system, the caller has to use other means to contact the receiver. The caller may, for example, have two mobile stations of which one uses the hybrid cellular telecommunication system and the other uses the cellular network. This is not very convenient.

In the second preferred embodiment of the method according to the invention, the mobile station may make a handover to the cellular network if the hybrid cellular telecommunication system rejects a call. This can be done, for example, by informing the mobile station of the call rejection (step 411 in FIG. 4), whereafter the mobile station automatically starts to register with the cellular network, for example by sending a location updating request. The hybrid cellular telecommunication system, which knows that the mobile is reacting to the call rejection, does not answer the location updating request, but lets the cellular network to take responsibility of the mobile station. Thereafter the caller can place the call to any receiver using the cellular network resources.

The difference between the first and second preferred embodiment of the method according to the invention is in the action after the call has been rejected. FIG. 5 shows the additional steps 501-503 that are added after step 411 to produce the flowchart of the second preferred embodiment of the method. In step 411 the hybrid cellular telecommunication system informs the mobile station of the rejected call. In step 501 the mobile station starts to make a handover to the cellular network. The cellular network registers the mobile station (step 502) and updates the information where to route the incoming calls to the mobile station. At the same time, the hybrid cellular telecommunication system updates its databases to route the possible calls to the mobile station via the cellular network. In step 503 the mobile station retries to call the receiver using the cellular network.

The method according to the invention does not specify when the mobile station makes a handover back to the hybrid cellular telecommunication system.

In the third preferred embodiment of the method according to the invention, incoming calls are restricted. Here the receiver of the call is reachable via the hybrid cellular telecommunication system. He may receive calls if, for example, they come from the premises of the company he works for. Similar criteria that are applied to outgoing calls may be applied to incoming calls, too.

The flowchart of the third preferred embodiment of the method according to the invention is similar to that presented in the FIG. 4. The differences are that the allowed identities and location areas of the caller are defined (steps corresponding to steps 402 and 403) and characteristics of the caller are checked (steps corresponding to steps 405, 407, 408 and 409). In a step corresponding to step 401 it is defined if calls from cellular network can be connected using the hybrid cellular telecommunication system. In a step corresponding to step 404 a call arrives for a mobile station that is reachable via the hybrid cellular telecommunication system. It step corresponding to step 406 it is checked if calls from the cellular network can be connected using the hybrid cellular telecommunication system.

If the hybrid cellular telecommunication system refuses to connect a call, it may inform the mobile station of an incoming call that could not be connected. Thereafter the mobile station may make a handover to the cellular network, and the call may be connected via the cellular network. This requires that the cellular network has means to retry establishing the calls. The hybrid cellular telecommunication system may, for example, tell the cellular network that the mobile station was not reachable and urge the cellular network to try again after a short delay. During the delay time the mobile station has time to make the handover to the cellular network and the call may be connected thereafter. Technically, this method may require that the call both to the hybrid cellular telecommunication system and to the mobile station when in the cellular network passes through the same cellular network switch, for example an MSC in the GSM network.

FIG. 6 shows an arrangement 600 for controlling calls in a hybrid cellular telecommunication system according to a preferred embodiment of the invention. The arrangement 600 is implemented in the hybrid cellular telecommunication system for example in a network element in a local non-cellular subsystem. It can be, for example, part of a local gatekeeper 117′ as presented in FIG. 7.

When either an incoming or an outgoing call is to be connected, the endpoint identifier block 601 deduces the identifiers of the first and second endpoint of the call. The endpoint identifiers can be, for example, the telephone number of the mobile stations involved in the call. In case of an outgoing call, the location area of the receiver has to be determined, and in case of an incoming call, the location area of the caller. Here we shall use term the second endpoint of the call for referring to the endpoint of the call whose location area must be determined. The first endpoint of the call is the mobile station that is reachable via the hybrid cellular telecommunication system.

The current location area block 602 is responsible for finding out the location area of the second endpoint of the call The current location area block 602 comprises means for requesting the location area of a certain endpoint and for receiving the location area information. If the second endpoint of the call is a mobile station of a subscriber to the hybrid cellular telecommunication system and the mobile station is reachable via the hybrid cellular telecommunication system, then the location area information can be found, for example, in a local subscriber database similar to the database 116 which FIG. 7 presents. If the second endpoint of the call is not reachable via the hybrid cellular telecommunication system and calls outside the hybrid cellular telecommunication system are allowed, the current location area block 602 may have means for requesting location area information from a public cellular network 130. The request and answer may pass, again using FIG. 7 as an example, through the subscriber database 118 in the common non-cellular subsystem 113 of the hybrid cellular telecommunication system.

The allowed location areas block 603 provides information on the location areas, for example the location area codes or dialing codes, from where the first endpoint of the call is allowed to receive calls and to where it is allowed to make calls. The allowed location areas may be specified, for example, for each hybrid cellular telecommunication system subscriber separately or for certain subscriber groups. The information of the allowed location areas may be stored, for example, in a local subscriber database 116 or in the subscriber database 118 in the common non-cellular system. The allowed location areas block 603 may comprise means for communicating with these network elements, if the information about the allowed location areas is not stored in the same network element where the arrangement 600 is implemented.

The allowed second endpoint identifiers block 604 provides information on the second endpoints with whom the first endpoint may establish a call. This information may be stored in the same network element where the arrangement 600 is implemented or in the subscriber databases 116 or 118, similarly as the information on the allowed location areas. The allowed second endpoint identifiers block may thus comprise means for communicating with other network elements.

The decision block 605 receives information about the allowed location areas and identities. It may comprise other logic or rules which are needed to make the decision about connecting the call. The decision about connecting the call is sent, for example, to the gatekeeper.

The arrangement 610 is typically in the public cellular network 130 as FIG. 7 illustrates. It may be implemented, for example, in the Mobile Switching Center (MSC) of a GSM network. It has means, 611 to communicate with the hybrid cellular telecommunication system. The hybrid cellular telecommunication system, for example the arrangement 610, sends a request stating, for example, an identifier of a cellular network subscriber. The block 612 determines the location area of the subscriber, for example by requesting the location area from other cellular network elements. The arrangement 610 sends a response to the hybrid cellular telecommunication system stating, for example, the location area code to the hybrid cellular telecommunication system.

The name of a given functional entity, such as the base station controller, is often different in the context of different telecommunication systems. For example, in the Universal Mobile Telecommunication System (UMTS) the functional entity corresponding to a base station controller (BSC) is the radio network controller (RNC). Therefore, the particular terminology used to denote various functional entities in this specification are only examples according to the GSM and RCP systems, and do not limit the methods or network elements according to the invention in any way.

Especially the UMTS and UMTS network elements may be used in future hybrid cellular telecommunication systems, and methods and network elements according to the invention may be implemented using UMTS and UMTS network elements.

The combination of the H.323 standard and IP networks has been used as an example of non-cellular telephony network. They do not either limit the methods and techniques that can be used in the non-cellular part of the hybrid cellular telecommunication system. Consequently, the methods and network elements according to the invention are not-limited to such methods or network elements that employ the H.323 standard or IP techniques.

A hybrid cellular telecommunication system has been presented here as an example of a telecommunication system that combines cellular network techniques and techniques that are neither cellular nor traditional fixed telephony techniques. The division of such a telecommunication system to the cellular and non-cellular subsystems have been used here to explain the system in a more tangible way. It is not limit the systems where the methods and network elements according to the invention are used to such systems that have all the distinct subsystems described here.

In view of the foregoing description it will be evident to a person skilled in the art that various modifications may be made within the scope of the invention. While a preferred embodiment of the invention has been described in detail, it should be apparent that many modifications and variations thereto are possible, all of which fall within the scope of the invention as defined by the appended claims.

1. A method (400) for controlling calls to and from a mobile station reachable via a hybrid cellular telecommunication system, where said mobile station is a first endpoint of a call and in which method a set of allowed location areas is defined (402), the method being characterized in that
the location area of a second endpoint of the call is determined (407),
decision about connecting the call via the hybrid cellular telecommunication system is made (408) based at least on the location area of said second endpoint, and
if connecting the call via the hybrid cellular telecommunication system is refused, connecting the call via a cellular telecommunication system is initiated.

2. A method according to claim 1, characterized in that the call is connected (410) via the hybrid cellular telecommunication system, if the location area of said second endpoint belongs to said set of allowed location areas.

3. A method according to claim 1, characterized in that
a set of allowed identifiers is defined (403),
an identifier specifying said second endpoint is determined, and
the call is connected via the hybrid cellular telecommunication system, if either the location area of said second endpoint belongs to said set of allowed location areas or the identifier, which specifies said second endpoint, belongs to said set of allowed identifiers.

4. A method according to claim 3, characterized in that the call is connected via the hybrid cellular telecommunication system, if both the location area of said second endpoint belongs to said set of allowed location areas and the identifier, which specifies said second endpoint, belongs to said set of allowed identifiers.

5. A method according to claim 3, characterized in that the identifier, which specifies said second endpoint, is a telephone number.

6. A method according to claim 3, characterized in that the identifier, which specifies said second endpoint, is a network address.

7. A method according to claim 3, characterized in that the identifier, which specifies said second endpoint, is an identifier related to a certain person.

8. A method according to claim 1, characterized in that said first endpoint of the call is making the call.

9. A method according to claim 1, characterized in that said first endpoint of the call is receiving the call.

10. A method according to claim 1, characterized in that said second endpoint is a mobile station and the location area of said second endpoint is determined using a location area code.

11. A method according to claim 10, characterized in that said second endpoint is reachable via the cellular network and said set of allowed location areas comprises at least certain location areas of the cellular network.

12. A method according to claim 10, characterized in that
more than one set of allowed location areas are defined and
an identifier, which specifies said second endpoint, is used to determine, which set of allowed location areas is used in deciding about connecting the call via the hybrid cellular telecommunication system.

13. A method according to claim 1, characterized in that said second endpoint is a fixed telephone and the location area of said second endpoint is determined using a dialing code.

14. An arrangement (600) for controlling calls, which use the resources of a hybrid cellular telecommunication system, to and from a certain mobile station which is a first endpoint of a call, which arrangement comprises means (601) for determining an identifier, which specifies a second endpoint of a call,
characterized in that it comprises
means (602) for determining the location area of said second endpoint,
means (603) for defining the allowed location areas for said second endpoint and
means (605) for deciding whether to connect the call using the hybrid cellular telecommunication system resources or using a cellular network based at least on the location area of said second endpoint.

15. An arrangement according to claim 14, characterized in that the means for determining the location area of said second endpoint comprise means for requesting the information from a cellular network.

16. An arrangement according to claim 15, characterized in that the means for determining the location area of said second endpoint comprise means for requesting the location area code from a GSM network.

17. An arrangement according to claim 15, characterized in that the means for determining the location area of said second endpoint comprise means for requesting the location area code from an UMTS network.

18. An arrangement according to claim 14, characterized in that it further comprises
means (604) for defining a set of identifiers for allowed said second endpoints of the call and
means (605) for deciding whether to connect the call using the hybrid cellular telecommunication system resources based on the identifier, which specifies said second endpoint.

19. An arrangement (610) in a cellular network, which arrangement comprises means (612) for determining the location area of a certain mobile station, characterized in that it comprises means (611) for receiving from an entity outside the cellular network a request comprising an identifier which specifies said mobile station and means (611) for sending to said entity a response indicating the location area of said mobile station.

20. An arrangement according to claim 19, characterized in that it is located in the GSM network.

21. An arrangement according to claim 19, characterized in that it is located in the UMTS network.
